(19) United States
(12) Patent Application Publication
(10) Pub. No.: US 2025/0309649 A1
(43) Pub. Date: Oct. 2, 2025

(54) Management of a distributed energy storage, DES, arrangement

(71) Applicant: Elisa Oyj, Helsinki (FI)

(72) Inventors: Simon HOLMBACKA, Helsinki (FI); Jukka-Pekka SALMENKAITA, Helsinki (FI)

(21) Appl. No.: 18/864,919

(22) PCT Filed: Jun. 1, 2023
(86) PCT No.: PCT/FI2023/050316

§ 371 Date: Nov. 12, 2024

(30) Foreign Application Priority Data
Jun. 6, 2022 (FI) 20225493

(51) Int. Cl. H02J 3/28; H02J 3/00; H02J 3/24

(52) U.S. Cl. CPC H02J 3/28; H02J 3/0012; H02J 3/24; H02J 2203/10

(57) ABSTRACT

A computer implemented method for managing a distributed energy storage, DES, arrangement, wherein the DES arrangement comprises a pool of nodes (121-125). The method is performed by detecting a balancing need for frequency balancing of electric grid; selecting a plurality of nodes of the DES arrangement for fulfilling a capacity requirement associated with the balancing need; sending activation requests to the selected nodes, wherein sending of the activation requests is performed in parallel; detecting an activation confirmation situation or an error situation for the selected nodes; aggregating capacity of the nodes for which an activation confirmation situation is detected; and reserving the aggregated capacity for the balancing need.

### TECHNICAL FIELD

The present disclosure generally relates to management of distributed energy storage, DES, arrangements.

### BACKGROUND

This section illustrates useful background information without admission of any technique described herein representative of the state of the art.

A distributed energy storage (DES) arrangement is a pool of spatially distributed nodes controlled by a centralized control system. The nodes may be distributed over a vast geographical area. The nodes can be powered either by the electric grid or by a battery system connected to the node. The battery systems may be resources maintained for example for emergency energy backup purposes, such as backup batteries of a wireless communication network. Additionally or alternatively, the battery systems may be resources owned by households or small and medium sized companies or other smaller scale operators. A DES arrangement can be used for forming a virtual power plant (VPP) comprising a plurality of spatially distributed nodes. In this way a larger capacity may be built by pooling together smaller scale resources. As backup batteries are not constantly used, the battery systems of the nodes can be used for further optimization purposes e.g. through the VPP.

Such VPPs may participate in balancing of electric grid or in intraday trading market. Transmission system operators (TSO) offer reserve markets where reserve providers, such as VPPs, can offer energy capacity for grid balancing purposes.

Now, there are provided some new considerations concerning management of distributed energy storage arrangements for the purpose of enabling participation in balancing of electric grid.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a computer implemented method for managing a distributed energy storage, DES, arrangement, wherein the DES arrangement comprises a pool of nodes. The method comprises
detecting a balancing need for frequency balancing of electric grid;
selecting a plurality of nodes of the DES arrangement for fulfilling a capacity requirement associated with the balancing need;
sending activation requests to the selected nodes, wherein sending of the activation requests is performed in parallel;
detecting an activation confirmation situation or an error situation for the selected nodes;
aggregating capacity of the nodes for which an activation confirmation situation is detected; and
reserving the aggregated capacity for the balancing need.

In some embodiments, the error situation is detected based on receipt of an error message or based on expiration of a timeout delay.

In some embodiments, the method further comprises placing in a blacklist the nodes for which an error situation is detected.

In some embodiments, the method further comprises excluding the nodes that are in the blacklist from being selected in the selection phase.

In some embodiments, the method further comprises generating maintenance ticket for the nodes that are in the blacklist.

In some embodiments, the method further comprises placing in a grey list such nodes for which retransmission of the activation request is needed.

In some embodiments, the method further comprises excluding the nodes that are in the grey list from being selected in the selection phase.

In some embodiments, the method further comprises using a separate communication thread for each selected node.

In some embodiments, the method further comprises waiting until all threads have joined before reserving the aggregated capacity for the balancing need.

In some embodiments, the activation requests are sent using Simple Network Management Protocol, SNMP.

In some embodiments, the activation requests are configured with a timeout delay of 500 ms and maximum number of retransmissions of 2.

In some embodiments, the method further comprises selecting and activating further nodes if the aggregated capacity does not fulfil the capacity requirement associated with the balancing need.

In some embodiments, the method further comprises performing the selection of plurality of nodes of the DES arrangement by selecting one or more extra nodes so that the capacity requirement associated with the balancing need is exceeded; and deactivating excess nodes if the aggregated capacity exceeds the capacity requirement associated with the balancing need.

In some embodiments, 5-10 extra nodes are selected.

According to a second example aspect of the present invention, there is provided an apparatus comprising means for performing the method of the first aspect or any related embodiment. The means may comprise a processor and a memory including computer program code, and wherein the memory and the computer program code are configured to, with the processor, cause the performance of the apparatus.

According to a third example aspect of the present invention, there is provided a computer program comprising computer executable program code which when executed by a processor causes an apparatus to perform the method of the first aspect or any related embodiment.

According to a fourth example aspect there is provided a computer program product comprising a non-transitory computer readable medium having the computer program of the third example aspect stored thereon.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment; and

FIG. 3A-3C show flow charts according to example embodiments;

FIG. 4 illustrates an example of capacity limits of a battery asset; and

FIG. 5 shows a flow chart according to further example embodiments.

### DETAILED DESCRIPTION

In the following description, like reference signs denote like elements or steps.

Various embodiments of present disclosure provide mechanisms to manage a distributed energy storage, DES, arrangement, wherein the DES arrangement comprises a pool of nodes. The nodes are spatially distributed entities that can be powered either by the electric grid or by a battery system connected to the node. The battery systems may be resources maintained for example for emergency energy backup purposes, such as backup batteries of a wireless communication network. Additionally or alternatively, the battery systems may be resources owned by households or small and medium sized companies or other smaller scale operators. As an alternative non-limiting example, the battery systems may be intended for storing energy from renewable sources such as solar panels and/or wind generators or even from a fuel-operated genset. Yet another additional or alternative, the intended use of the battery systems is optimization of self-consumption. The battery system may be a hybrid system using multiple energy sources.

In general, the battery systems in this disclosure refer to battery systems that are able to handle regular charge and discharge cycles. For example, lithium-ion batteries are such battery systems. In more detail, one or more of the following battery technologies may be represented in the pool of DES nodes: lithium-nickel-cobalt, NCA, lithium-iron-phosphate, LFP, lithium-nickel-manganese-cobalt, NMC, flow batteries, and solid-state batteries. The battery systems may have different properties with regard to price, durability, physical size and wear depending for example on the battery technology and storage capacity.

In general, lithium-ion batteries should not regularly exceed extreme low or high charge values. For example, state of charge below 5% or above 95% should be avoided. Such limitations should be taken into account in usage of the lithium-ion batteries to avoid increased wear of the batteries.

A DES arrangement can be used for forming a virtual power plant (VPP) comprising a plurality of spatially distributed nodes. In this way a larger capacity may be built by pooling together smaller scale resources. As backup batteries are not constantly used, the battery systems of the nodes can be used for further optimization purposes e.g. through the VPP.

Such VPPs may participate in balancing of electric grid or in intraday trading market. Transmission system operators (TSO) offer reserve markets where reserve providers, such as VPPs, can offer energy capacity for grid balancing purposes.

Frequency balancing of electric grid may be arranged for example using automatic Frequency Restoration Reserve, aFRR, or Frequency Containment Reserve, FCR, capacity market. aFRR is a centralized automatically activated reserve. Its activation is based on a power change signal calculated on the base of the frequency deviation in the Nordic synchronized area. Its purpose is to return the frequency to the nominal value. FCR is an active power reserve that is automatically controlled based on the frequency deviation. FCR may be Frequency Containment Reserve for Normal Operation, FCR-N, or Frequency Containment Reserve for Disturbances, FCR-D. Their purpose is to contain the frequency during normal operation and disturbances.

The frequency balancing may comprise up regulation and/or down regulation. Up regulation means increasing power production or decreasing consumption. Down regulation means decreasing power production or increasing consumption.

In order to participate in the grid balancing, the DES nodes need to be activated upon detecting a balancing need. The balancing need may be automatically detected or the balancing need may be signalled in an balancing request.

Various embodiments of present disclosure provide a centralized coordinator for managing a DES arrangement so that the DES arrangement can be used for participating in frequency balancing of electric grid e.g. in the aFRR and/or FCR capacity market.

A challenge in managing the DES arrangement is that activation of the DES nodes needs to be fast when the balancing need emerges. For example, aFRR in the Nordic market may require a response within 10 seconds of the balancing request. In order to meet the 10 second time limit, unpredictable latency in the range of seconds is not acceptable in the process of activating the DES nodes. In many cases the balancing need involves capacity requirement in the range of Megawatts and may require activation of thousands of DES nodes. That is, thousands of activations are possibly needed every 10 seconds. The DES arrangement on the other hand may include possibly faulty or unreachable nodes. This causes a synchronization problem in meeting the capacity demand in sufficiently short timeframe. Further, it is to be noted that switching between charge and discharge of batteries may require 1 to 3 seconds time before rectifiers controlling the battery system has switched the power electronics into the desired configuration and the power is flowing in the intended way.

Various embodiments of present disclosure are beneficial and applicable even with significantly looser timing requirements. Depending on implementation details, the available time frame for performing the activation may be for example 30-300 seconds.

One aim of present disclosure is to achieve efficient use of nodes of DES for balancing of electric grid. In this way grid balancing is improved whereby more stable energy source may be achieved without additional environmental burden.

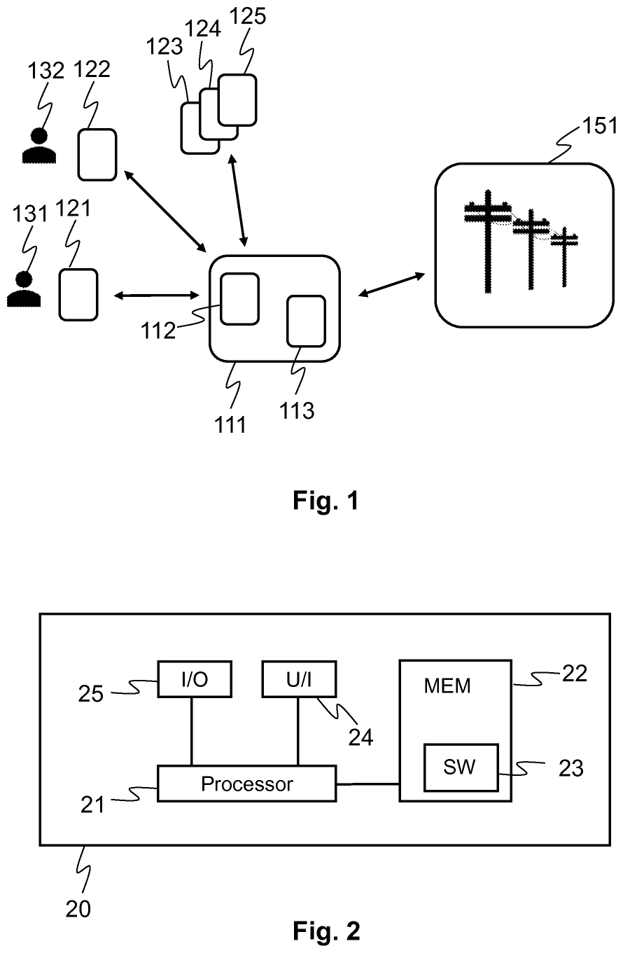

FIG. 1 schematically shows an example scenario according to an embodiment. The scenario shows a DES arrangement formed of a pool of nodes 121-125. The nodes 121-125 may be located at different geographical locations, but equally there may be plurality of nodes at the same location. FIG. 1 shows the nodes 123-125 at the same location and the nodes 121 and 122 individually at different locations. The nodes 121 and 122 are owned by individuals 131 and 132, respectively. The nodes 123-125 are co-located nodes owned for example by a small company. It is to be noted that this is only a non-limiting illustrative example and in practical implementations many different setups are possible.

Further, the scenario shows a coordinator system 111. Still further, FIG. 1 shows an electric grid 151.

The coordinator system 111 is configured to implement at least some example embodiments of present disclosure to manage the nodes 121-125 of the DES arrangement. For this purpose, the coordinator system 111 is operable to interact with the nodes 121-125 or equipment associated thereto. The coordinator system 111 comprises a first interface 112 for such interaction. Communication over the first interface 112 is implemented for example using Simple Network Management Protocol (SNMP). Additionally, the coordinator system 111 is operable to interact with the electric grid 151 or equipment associated thereto to coordinate participation in frequency balancing of the electric grid. The coordinator system 111 comprises a second interface 113 for this purpose.

The coordinator system 111 may receive compensation based on the frequency balancing carried out for the electric grid. The compensation may depend on actual activation of frequency balancing and/or on reserving capacity for the possible frequency balancing needs.

FIG. 2 shows a block diagram of an apparatus 20 according to an embodiment. The apparatus 20 is for example a general purpose computer, cloud computing environment or some other electronic data processing apparatus. The apparatus 20 can be used for implementing at least some embodiments of present disclosure. That is, with suitable configuration the apparatus 20 is suited for operating for example as the coordinator system 111 of FIG. 1.

The apparatus 20 comprises a communication interface 25; a processor 21; a user interface 24; and a memory 22. The apparatus 20 further comprises software 23 stored in the memory 22 and operable to be loaded into and executed in the processor 21. The software 23 may comprise one or more software modules and can be in the form of a computer program product.

The processor 21 may comprise a central processing unit (CPU), a microprocessor, a digital signal processor (DSP), a graphics processing unit, or the like. FIG. 2 shows one processor 21, but the apparatus 20 may comprise a plurality of processors.

The user interface 24 is configured for providing interaction with a user of the apparatus. Additionally or alternatively, the user interaction may be implemented through the communication interface 25. The user interface 24 may comprise a circuitry for receiving input from a user of the apparatus 20, e.g., via a keyboard, graphical user interface shown on the display of the apparatus 20, speech recognition circuitry, or an accessory device, such as a headset, and for providing output to the user via, e.g., a graphical user interface or a loudspeaker.

The memory 22 may comprise for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories. The memory 22 may serve the sole purpose of storing data, or be constructed as a part of an apparatus 20 serving other purposes, such as processing data.

The communication interface 25 may comprise communication modules that implement data transmission to and from the apparatus 20. The communication modules may comprise a wireless or a wired interface module(s) or both. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. The communication interface 25 may support one or more different communication technologies. The apparatus 20 may additionally or alternatively comprise more than one of the communication interfaces 25.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like.

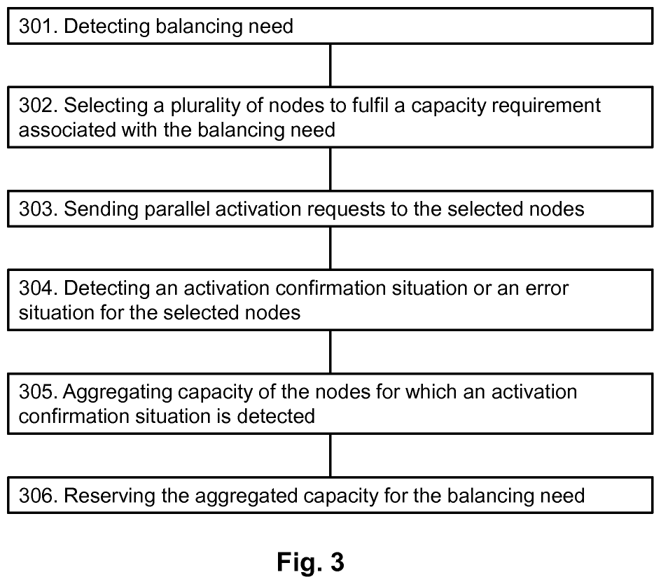

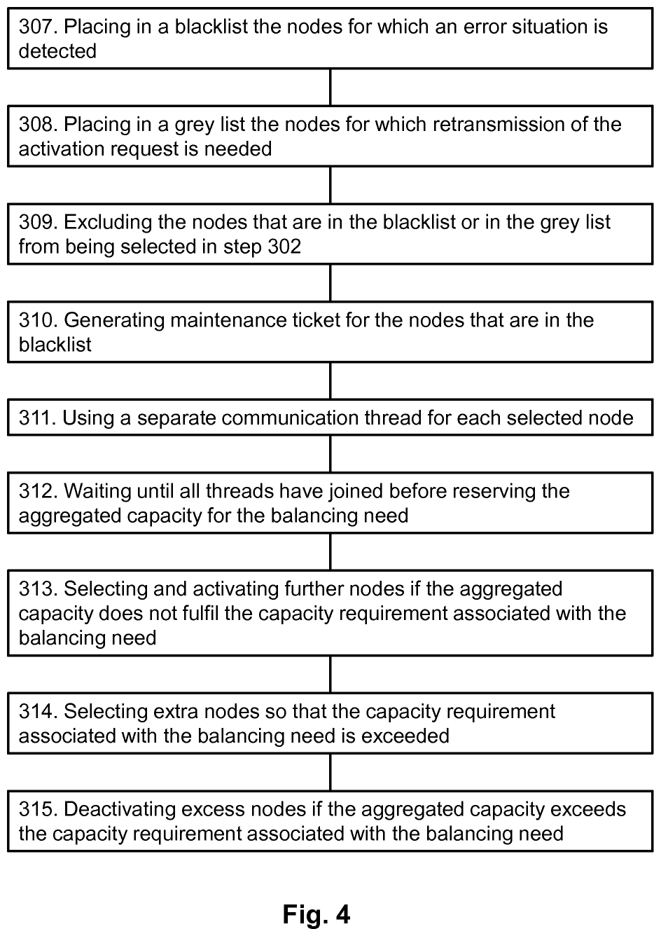

FIGS. 3 and 4 show flow charts according to example embodiments. FIGS. 3 and 4 illustrate processes comprising various possible steps including some optional steps while also further steps can be included and/or some of the steps can be performed more than once. The processes may be implemented in the coordinating system 111 of FIG. 1 and/or in the apparatus 20 of FIG. 2. The processes are implemented in a computer program code and does not require human interaction unless otherwise expressly stated. It is to be noted that the processes may however provide output that may be further processed by humans and/or the processes may require user input to start.

The process of FIG. 3 comprises the following steps:

301: A balancing need is detected. The balancing need relates to frequency balancing of electric grid. The balancing need may relate to up regulation or down regulation. The balancing need has a capacity requirement associated thereto. The capacity requirement may be a predefined value or the capacity requirement may vary.

The balancing need may be detected based on receiving a balancing request requesting activation of energy sources. The capacity requirement may be signaled in the balancing request. Alternatively, the balancing need may be detected based on monitoring the electric grid.

302: A plurality of nodes of the DES arrangement are selected for fulfilling the capacity requirement associated with the balancing need.

The selection may be implemented by randomly choosing enough nodes to fulfil the capacity requirement or there may be some logic in choosing the nodes. Additionally or alternatively, the selection may be based on properties of battery systems of the nodes, such as battery wear profile, available capacity, type of the battery system, reliability of the battery system, operating conditions of the battery system (e.g. temperature and humidity).

303: Activation requests are sent to the selected nodes. The sending of the activation requests is performed in parallel. That is, instead of sequentially activating the nodes, all activation requests are sent at the same time. In this way, time can be saved, and the activation task can be completed in a relatively short timeframe compared to sequentially sending thousands of activation requests.

The activation requests are sent for example using Simple Network Management Protocol, SNMP.

304: An activation confirmation situation or an error situation is detected for the selected nodes. That is, for each node, either an activation confirmation situation or an error situation is being detected. In many cases, an activation confirmation situation is detected for most of the nodes and the error situation is detected only for few nodes. That is, for most of the nodes, the activation succeeds. Some nodes may however fail to activate. The nodes may remain unresponsive, or the nodes may be broken.

In an embodiment, the activation confirmation situation is detected based on receipt of a confirmation message. The confirmation message may be confirmation of receipt of the activation request at the respective node. Additionally or alternatively, the confirmation message may be confirmation of activating the respective node. In a further option, there may be an additional check on whether a node that sent a confirmation message was actually activated. Such additional check may be performed after or in connection with the steps 305 and 306. In an embodiment, the error situation is detected based on receipt of an error message or based on expiration of a timeout delay.

305: Capacity of the nodes, for which an activation confirmation situation is detected, is aggregated. That is, the total actually activated capacity is determined.

306: The aggregated capacity is reserved for the balancing need. The aggregated capacity may be signaled as a response to a balancing request, or the aggregated capacity may be otherwise reserved for balancing purpose.

Maximum processing delay caused by sending the activation requests and waiting for receipt of the confirmation messages can be calculated as

maximum delay=timeout delay*number of retransmissions.

In an embodiment, the activation requests are configured with a timeout delay of 500 ms and maximum number of retransmissions of 2. Clearly this is only one example and other values may be used.

The process of FIG. 4 comprises the following steps. One or more of the steps of FIG. 4 may be implemented in the process of FIG. 3. Clearly all steps of FIG. 4 are not mandatory.

307: The nodes for which an error situation is detected in step 304 of FIG. 3 are placed in a blacklist.

308: The nodes for which retransmission of the activation request is needed in step 303 or 304 of FIG. 3 are placed in a grey list.

309: The nodes that are in the blacklist or in the grey list are excluded from being selected in the selection phase of step 302 of FIG. 3. In this way nodes that previously failed are not selected in the next activation round.

310: A maintenance ticket is generated for the nodes that are in the blacklist. Based on the maintenance ticket, maintenance personnel will check the node. The node may be removed from the blacklist after the node has been checked and repaired if needed.

The nodes may be released from the grey list after a predefined time period. The reason for requiring retransmission may be a temporary failure that may spontaneously disappear and therefore physical visit by maintenance personnel is not necessarily needed.

311: A separate communication thread is used for each selected node in step 303 of FIG. 3.

312: The process waits until all threads have joined before reserving the aggregated capacity for the balancing need in steps 305 and 306 of FIG. 3.

SNMP, which is usually used in communication to the DES nodes, does not support multicast transmissions and point-to-point communication is the only means of transmission. For this reason multiple point-to-point threads are used in parallel and the threads are later synchronized.

313: Further nodes are selected and activated, if the aggregated capacity in step 305 of FIG. 3 does not fulfil the capacity requirement associated with the balancing need. Implementation of this feature naturally needs to take into account the requirement of completing the whole process in required timeframe (e.g. 10 seconds).

314: One or more extra nodes are selected in step 302 of FIG. 3 so that the capacity requirement associated with the balancing need is exceeded. For example, 5-10 extra nodes may be selected, but this is only an illustrative example, and the number of extra nodes may vary from this example.

315: The excess nodes are deactivated, if the aggregated capacity in step 305 of FIG. 3 exceeds the capacity requirement associated with the balancing need.

By initially selecting extra nodes one achieves that it is more likely to be able to meet the capacity requirement in full. Deactivation of possible excess nodes is an additional task to perform, but such deactivation is not necessarily always needed. In any case the deactivation can be seen as a minor task.

In an embodiment, full activation of the capacity requirement associated with the balancing need is performed in multiple rounds of the steps 302-305 of FIG. 3. In this way larger activation may be performed by consecutively activating multiple smaller sets of nodes. For example, if there is 30-300 seconds time frame available for performing the full activation, multiple 10 second activation rounds may be performed until the capacity requirement is fulfilled.

In embodiments, wherein the activation confirmation situation is detected based on confirmation of receipt of the activation request at the respective node the coordinator system of present disclosure may aggregate and reserve capacity based on the assumption that such nodes likely perform the actual activation, too. However, the coordinator system may nevertheless continue to monitor the actual activation of the nodes and reserved capacity. Based on the monitoring, the coordinator system may then activate/deactivate further nodes to correct things if need be.

Without in any way limiting the scope, interpretation, or application of the appended claims, a technical effect of one or more of the example embodiments disclosed herein is improved management of a DES arrangement. For example activation of nodes of the DES arrangement may be improved by using embodiments of present disclosure. In this way ability to efficiently use DES arrangement for participating in electric grid balancing may be improved. Efficient usage of already existing energy resources may provide environmental benefits.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A computer implemented method for managing a distributed energy storage; (DES) arrangement, wherein the DES arrangement comprises a pool of nodes; the method comprising:
detecting a balancing need for frequency balancing of electric grid;
selecting a plurality of nodes of the DES arrangement for fulfilling a capacity requirement associated with the balancing need;
sending activation requests to the selected nodes, wherein sending of the activation requests is performed in parallel;
detecting an activation confirmation situation or an error situation for the selected nodes;
aggregating capacity of the nodes for which the activation confirmation situation is detected; and
reserving the aggregated capacity for the balancing need; the method further comprising:
performing the selection of plurality of nodes of the DES arrangement by selecting one or more extra nodes so that the capacity requirement associated with the balancing need is exceeded; and deactivating excess nodes if the aggregated capacity exceeds the capacity requirement associated with the balancing need.

2. The method of claim 1, wherein the error situation is detected based on receipt of an error message.

3. The method of claim 1, further comprising placing in a blacklist the nodes for which an error situation is detected.

4. The method of claim 3, further comprising excluding the nodes that are in the blacklist from being selected in the selection phase.

5. The method of claim 4, further comprising generating a maintenance ticket for the nodes that are in the blacklist.

6. The method of claim 1, further comprising placing in a grey list such nodes for which retransmission of the activation request is needed.

7. The method of claim 6, further comprising excluding the nodes that are in the grey list from being selected in the selection phase.

8. The method of claim 1, further comprising using a separate communication thread for each selected node.

9. The method of claim 8, further comprising waiting until all threads have joined before reserving the aggregated capacity for the balancing need.

10. The method of claim 1, wherein the activation requests are sent using Simple Network Management Protocol, SNMP.

11. The method of claim 1, wherein the activation requests are configured with a timeout delay of 500 (in milliseconds, ms) and a maximum number of retransmissions of 2.

12. The method of claim 1, further comprising selecting and activating further nodes if the aggregated capacity does not fulfil the capacity requirement associated with the balancing need.

13. (canceled)

14. The method of claim 1, wherein 5-10 extra nodes are selected.

15. (canceled)

16. An apparatus comprising a processor and a memory including computer program code, and wherein the memory and the computer program code are configured to, with the processor, cause the apparatus to perform the method of claim 1.

17. A non-transitory computer readable medium having the computer program comprising computer executable program code which when executed in an apparatus causes the apparatus to perform the method of claim 1.

18. The method of claim 1, wherein the error situation is detected based on expiration of a timeout delay.

19. The method of claim 3, further comprising placing in a grey list such nodes for which retransmission of the activation request is needed.
